(19) United States
(12) Patent Application Publication
(10) Pub. No.: US 2026/0127675 A1
(43) Pub. Date: May 7, 2026

(54) SYSTEM AND METHOD FOR MANAGING FINANCIAL DATA USING CONTEXT-AWARE DATA FRAMEKWORK FOR REAL-TIME CAPITAL CONTROL

(71) Applicant: VINAY KUMAR GALI, GILBERT, AZ (US)

(72) Inventor: VINAY KUMAR GALI, GILBERT, AZ (US)

(21) Appl. No.: 19/434,563

(22) Filed: Dec. 29, 2025

(51) Int. Cl. G06Q 40/06; G06F 16/23

(52) U.S. Cl. CPC G06Q 40/063; G06F 16/23

(57) ABSTRACT

A system and method for managing financial data using a context-aware data framework for real-time capital control are disclosed. The method includes receiving, at a plurality of distributed processing nodes (106a, 106b, 106c . . . 106n), a plurality of financial transaction data streams from a plurality of distributed data sources (104a, 104b, 104c . . . 104n). The method includes generating the context-aware data framework. The method includes detecting one or more variations in one or more transaction context, assessed risk exposure, and capital flow conditions. The method includes updating one or more database states. The method includes executing one or more real-time capital control operations within the context-aware data framework. The method includes replicating, execution of the one or more real-time capital control operations, the updated one or more database states across the plurality of distributed processing nodes. The method includes generating one or more immutable contextual log records within the context-aware data framework.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of financial data management systems. More particularly, to systems and methods for managing financial data using context-aware data framework with autonomous database state evolution for real-time capital control.

### BACKGROUND OF THE INVENTION

In financial computing environments, financial institutions operate across distributed systems that continuously generate large volumes of transaction data originating from various sources. The transaction data streams are often processed independently by separate platforms responsible for transaction execution, liquidity management, compliance monitoring, and reporting. As a result, contextual relationships among financial entities, transaction attributes, regulatory constraints, and capital exposure conditions are fragmented across isolated data repositories, limiting the ability of existing systems to form a unified, real-time view of capital position and compliance posture.

Conventional financial data management solutions typically rely on static data schemas and predefined rule sets that are evaluated in batch or near-batch modes. The aforementioned approaches are not well suited to dynamically changing transaction contexts, evolving regulatory requirements, or rapid shifts in capital flow conditions. When transaction volumes increase or when regulatory parameters vary across institutions, the aforementioned systems struggle to adapt without manual intervention, leading to delayed responses, inconsistent capital controls, and increased operational risk.

Existing real-time capital control mechanisms are constrained by limited coordination across distributed processing nodes. Updates to capital allocation or compliance thresholds are often applied locally, with synchronization occurring asynchronously or through centralized reconciliation processes. This can result in transient inconsistencies in capital control states across the distributed processing nodes, increasing the risk of over-allocation, liquidity imbalance, or regulatory breaches during high-throughput transaction periods.

Additionally, many known financial data frameworks provide audit and compliance functionality through separate logging or reporting subsystems that operate independently of transaction processing and state management. Such decoupled audit mechanisms often fail to preserve the contextual linkage between transaction data, state transitions, and applied control actions. Consequently, reconstructing an accurate and verifiable history of how capital control decisions are derived becomes complex, time-consuming, and error-prone, particularly in regulatory review or dispute resolution scenarios.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for managing financial data using a context-aware data framework for real-time capital control is disclosed. The method includes receiving, at a plurality of distributed processing nodes, a plurality of financial transaction data streams from a plurality of distributed data sources in real time. The method includes generating the context-aware data framework based on the received plurality of financial transaction data streams. The context-aware data framework comprises one or more adaptive data structures configured to dynamically encode one or more semantic relationships among a plurality of financial entities, a plurality of transaction attributes, and a plurality of regulatory parameters. The one or more semantic relationships establish contextual dependencies used for subsequent database state evaluation. The method includes detecting one or more variations in one or more transaction context, assessed risk exposure, and capital flow conditions within the context-aware data framework, by analyzing changes in the generated one or more semantic relationships encoded by the one or more adaptive data structures. The method includes updating one or more database states within the context-aware data framework by executing one or more machine-implemented state transition rules based on the detected one or more variations. The method includes executing one or more real-time capital control operations within the context-aware data framework by applying one or more adaptive constraint enforcement mechanisms to at least one of transaction routing, liquidity allocation, and compliance threshold management based on the updated one or more database states. The method includes replicating, execution of the one or more real-time capital control operations, the updated one or more database states across the plurality of distributed processing nodes by performing consensus-based propagation. The consensus-based propagation maintains a consistent capital control state across the plurality of distributed processing nodes. The method includes generating, subsequent to the replication of the updated database states, one or more immutable contextual log records within the context-aware data framework. The one or more immutable contextual log records configured to store the received plurality of financial transaction data streams and corresponding state transition events. The one or more immutable contextual log records enable traceable regulatory oversight of the one or more real-time capital control operations.

In accordance with another embodiment of the present disclosure, a system for managing financial data using a context-aware data framework for real-time capital control is disclosed. The system includes a memory and at least one processor is operatively coupled to the memory. The at least one processor is configured to receive, at a plurality of distributed processing nodes, a plurality of financial transaction data streams from a plurality of distributed data sources in real time. The at least one processor is configured to generate, based on the received plurality of financial transaction data streams, the context-aware data framework comprising one or more adaptive data structures configured to dynamically encode one or more semantic relationships among a plurality of financial entities, a plurality of transaction attributes, and a plurality of regulatory parameters. The generated semantic relationships establish contextual dependencies used for subsequent database state evaluation. The at least one processor is configured to detect, within the context-aware data framework, one or more variations in one or more transaction context, assessed risk exposure, and capital flow conditions by analyzing changes in the one or more semantic relationships encoded by the one or more adaptive data structures. The at least one processor is configured to update, in response to the detected one or more variations, one or more database states within the context-aware data framework by executing one or more machine-implemented state transition rules. The at least one processor is configured to execute, based on the updated one or more database states, one or more real-time capital control operations within the context-aware data framework by applying one or more adaptive constraint enforcement mechanisms to at least one of transaction routing, liquidity allocation, and compliance threshold management. The at least one processor is configured to replicate, execution of the one or more real-time capital control operations, the updated one or more database states across the plurality of distributed processing nodes by performing consensus-based propagation. The consensus-based propagation maintains a consistent capital control state across the distributed nodes. The at least one processor is configured to generate, subsequent to the replication of the updated database states, one or more immutable contextual log records within the context-aware data framework. The one or more immutable contextual log records configured to configured to store the received plurality of financial transaction data streams and corresponding state transition events. The one or more immutable contextual log records enable traceable regulatory oversight of the one or more real-time capital control operations.

In accordance with another embodiment of the present disclosure, a non-transitory computer-readable medium storing instructions that, when executed, cause a processor to receive, at a plurality of distributed processing nodes, a plurality of financial transaction data streams from a plurality of distributed sources in real time. The processor is configured to generate, based on the received plurality of financial transaction data streams, the context-aware data framework comprising one or more adaptive data structures configured to dynamically encode semantic relationships among a plurality of financial entities, a plurality of transaction attributes, and a plurality of regulatory parameters. The generated semantic relationships establish contextual dependencies used for subsequent database state evaluation. The processor is configured to detect, within the context-aware data framework, one or more variations in one or more transaction context, assessed risk exposure, and capital flow conditions by analyzing changes in the semantic relationships encoded by the adaptive data structures. The processor is configured to update, in response to the detected one or more variations, one or more database states within the context-aware data framework by executing one or more machine-implemented state transition rules. The processor is configured to execute, based on the updated one or more database states, one or more real-time capital control operations within the context-aware data framework by applying one or more adaptive constraint enforcement mechanisms to at least one of transaction routing, liquidity allocation, and compliance threshold management. The processor is configured to replicate, execution of the one or more real-time capital control operations, the updated one or more database states across the plurality of distributed processing nodes by performing consensus-based propagation. The consensus-based propagation maintains a consistent capital control state across the distributed nodes. The processor is configured to generate, subsequent to the synchronization of the updated database states, one or more immutable contextual log records within the context-aware data framework, wherein the one or more immutable contextual log records configured to configured to store the plurality of financial transaction data streams and corresponding state transition events. The one or more immutable contextual log records enable traceable regulatory oversight of the one or more real-time capital control operations.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an environment of a system for managing financial data using a context-aware data framework for real-time capital control, in accordance with an embodiment of the present disclosure;

FIG. 2 is a block diagram depicting the system for managing financial data using a context-aware data framework for real-time capital control, in accordance with an embodiment of the present disclosure; and

FIG. 3 illustrates a flowchart depicting a method for updating the one or more optimization policies in distributed cloud environments, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

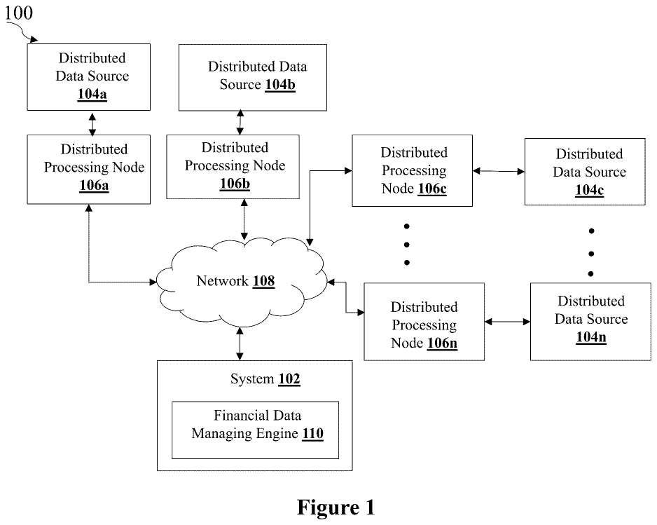

An environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram depicting an environment 100 of a system for managing financial data using a context-aware data framework for real-time capital control, in accordance with an embodiment of the present disclosure. The environment 100 may include a plurality of distributed data sources 104a, 104b, 104c . . . 104n configured to generate financial transaction data streams in real time. The plurality of distributed data sources 104a, 104b, 104c . . . 104n may include, but are not limited to, transaction processing systems, payment gateways, trading platforms, or other financial systems operating across different geographic or regulatory jurisdictions. The financial transaction data streams generated by the plurality of distributed data sources 104a, 104b, 104c . . . 104n may be transmitted to a plurality of distributed processing nodes 106a, 106b, 106c . . . 106n. The plurality of distributed processing nodes 106a, 106b, 106c . . . 106n may be communicated with each other through a network 108. The network 108 may include one or more wired or wireless networks, including private networks, public networks, or a combination thereof, supporting secure and low-latency data exchange between components of the environment 100.

Further, the system 102 may include a financial data management engine 110. In an embodiment, the system 102 may be implemented within the plurality of distributed processing nodes 106a, 106b, 106c . . . 106n. In another embodiment, the system 102 may be externally connected to the plurality of distributed processing nodes 106a, 106b, 106c . . . 106n. Yet, in another embodiment, some part of the system 102 may be implemented within the plurality of distributed processing nodes 106a, 106b, 106c . . . 106n and remaining part of the system 102 may be externally connected to the plurality of distributed processing nodes 106a, 106b, 106c . . . 106n.

In an embodiment, each distributed processing node 106a, 106b, 106c . . . 106n may include one or more processors and memory resources configured to execute a financial data management engine 110. The financial data management engine 110 may be configured to receive the plurality of financial transaction data streams and to generate and maintain a context-aware data framework. The context-aware data framework may include one or more adaptive data structures configured to encode semantic relationships among financial entities, transaction attributes, and regulatory parameters derived from the received financial transaction data streams.

The context-aware data framework may be operatively coupled to a database system that stores one or more database states representing capital allocation, liquidity availability, and compliance exposure. The database system may support machine-implemented state transition rules that update the one or more database states in response to detected variations in transaction context, assessed risk exposure, or capital flow conditions as determined within the context-aware data framework.

In an embodiment, the system 102 may be configured to detect one or more variations within the context-aware data framework in one or more transaction context, assessed risk exposure, and capital flow conditions by analyzing changes in the generated semantic relationships encoded by the one or more adaptive data structures. Further, the system 102 may be configured to update the one or more database states within the context-aware data framework based on the detected one or more variations. The one or more database states may be updated by executing one or more machine-implemented state transition rules. The one or more database states may indicate an evolved capital and compliance posture derived from the detected variations.

In an embodiment, the system 102 may be configured to execute one or more real-time capital control operations within the context-aware data framework based on the updated one or more database states. The one or more real-time capital control operations may be executed by applying one or more adaptive constraint enforcement mechanisms to transaction routing, liquidity allocation, and compliance threshold management.

In an embodiment, the system 102 may be configured to replicate the updated one or more database states across the plurality of distributed processing nodes 106a, 106b, 106c . . . 106n based on execution of the one or more real-time capital control operations. The updated one or more database states may be replicated by performing consensus-based propagation. The consensus-based propagation may maintain a consistent capital control state across the plurality of distributed processing nodes 106a, 106b, 106c . . . 106n.

In an embodiment, the system 102 may be configured to generate one or more immutable contextual log records within the context-aware data framework subsequent to the synchronization of the updated database states. The one or more immutable contextual log records may be configured to store the plurality of financial transaction data streams and corresponding state transition events. The one or more immutable contextual log records may enable traceable regulatory oversight of the one or more real-time capital control operations.

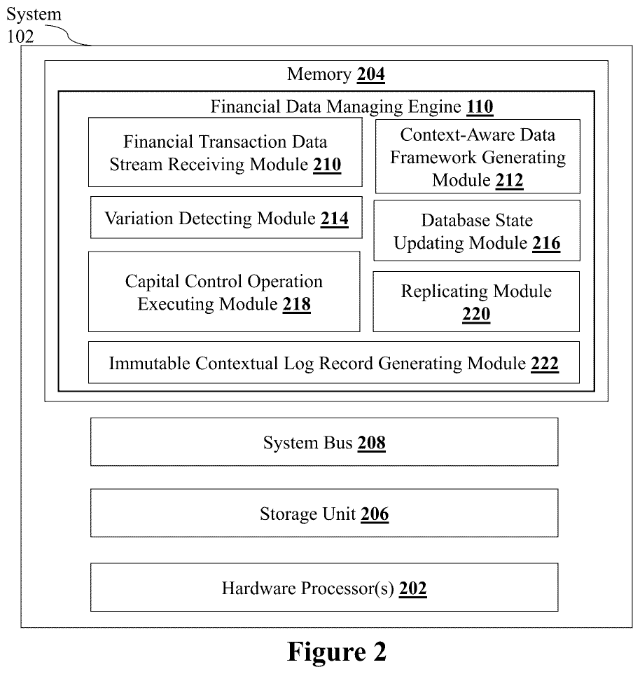

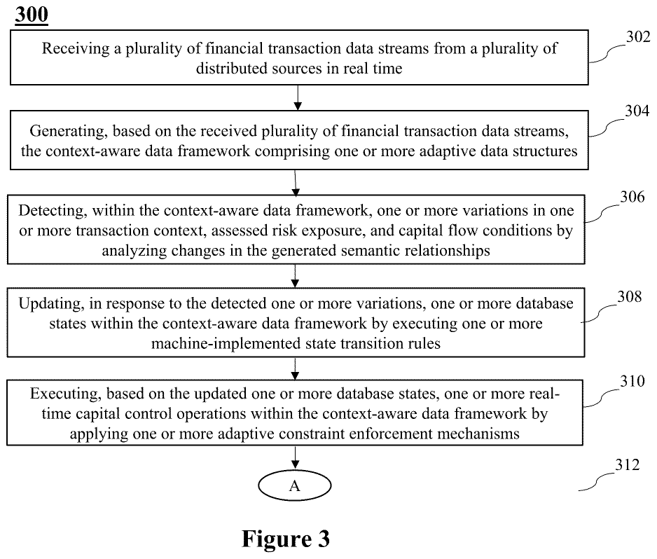

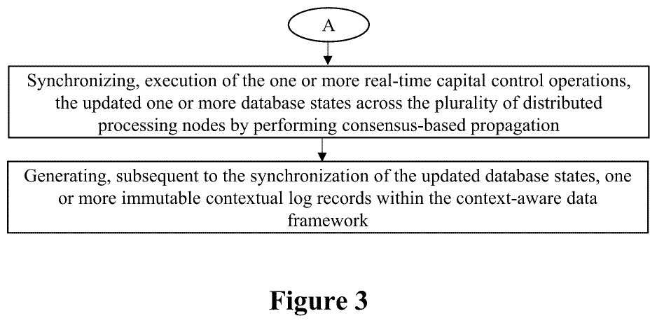

Although illustrated as discrete components, the elements shown in FIG. 1 may be combined, distributed, or implemented as software, hardware, or a combination thereof without departing from the scope of the present disclosure. The configuration of FIG. 1 is provided for purposes of explanation and does not limit the implementation of the disclosed context-aware data framework. The system 102 has been further detailed with reference to FIG. 2 and FIG. 3.

FIG. 2 is a block diagram 200 depicting the system 102 for managing financial data using a context-aware data framework for real-time capital control, in accordance with an embodiment of the present disclosure.

According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include the financial data managing engine 110 in the form of programmable instructions executable by the one or more hardware processors 202. Further, the financial data managing engine 110 may include a financial transaction data stream receiving module 210, a context-aware data framework generating module 212, a variation detecting module 214, a database state updating module 216, a capital control operation executing module 218, and a replicating module 220, and an immutable contextual log record generating module 222.

The financial transaction data stream receiving module 210 may be configured to receive the plurality of financial transaction data streams from the plurality of distributed data sources 104a, 104b, 104c . . . 104n in real time. The received financial transaction data streams may provide input data for constructing and updating the context-aware data framework.

Further, the context-aware data framework generating module 212 may be configured to generate the context-aware data framework based on the received plurality of financial transaction data streams. The context-aware data framework generating module 212 may include the one or more adaptive data structures configured to dynamically encode the semantic relationships among the plurality of financial entities, a plurality of transaction attributes, and a plurality of regulatory parameters. The generated semantic relationships may establish contextual dependencies used for subsequent database state evaluation. The one or more adaptive data structures may include graph-based data structures having dynamically weighted edges. The one or more weighted edges may be updated in real time based on observed changes in transaction frequency, capital flow direction, or regulatory parameter relevance.

In an embodiment, the context-aware data framework generating module 212 may be configured to construct a multi-layer data representation. The multi-layer data representation may include an entity relationship layer encoding associations between financial entities, a transaction context layer encoding temporal and behavioral attributes of transactions. The multi-layer data representation may include a regulatory context layer encoding jurisdiction-specific compliance parameters. The updates in layer trigger recalculation of contextual dependencies in the remaining layers.

In an embodiment, the variation detecting module 214 may be configured to detect one or more variations in one or more transaction context, assessed risk exposure, and capital flow conditions within the context-aware data framework. The one or more variations may be detected by analyzing changes in the generated semantic relationships encoded by the adaptive data structures. The variation detecting module 214 may be configured to detect the one or more variations in the transaction context. Further, the variation detecting module 214 may be configured to perform incremental comparison between a current context snapshot and a prior context snapshot stored within the context-aware data framework.

In an embodiment, the database state updating module 216 may be configured to update the one or more database states within the context-aware data framework based on the detected one or more variations. The one or more database states may be updated by executing one or more machine-implemented state transition rules. The updated one or more database states may include a capital allocation state, a liquidity availability state, and a compliance exposure state. Each of the one or more database states may be maintained as a versioned data object to enable rollback and historical comparison. The database state updating module 216 may be configured to apply a rule evaluation pipeline configured to execute state transitions only upon satisfaction of a context deviation condition and a capital exposure threshold condition.

In an embodiment, the capital control operation executing module 218 may be configured to execute one or more real-time capital control operations within the context-aware data framework based on the updated one or more database states. The one or more real-time capital control operations may be executed by applying one or more adaptive constraint enforcement mechanisms to at least one of transaction routing, liquidity allocation, and compliance threshold management. The one or more adaptive constraint enforcement mechanisms may be dynamically derived from the evolved one or more database states.

In an embodiment, the replicating module 220 may be configured to replicate the updated one or more database states across the plurality of distributed processing nodes 106a, 106b, 106c . . . 106n by performing consensus-based propagation based on execution of the one or more real-time capital control operations. The updated one or more database states may be replaced by performing consensus-based propagation. The consensus-based propagation may maintain a consistent capital control state across the plurality of distributed processing nodes 106a, 106b, 106c . . . 106n.

In an embodiment, the immutable contextual log record generating module 222 may be configured to generate one or more immutable contextual log records within the context-aware data framework subsequent to the replication of the updated database states. The one or more immutable contextual log records may be configured to store the plurality of financial transaction data streams and corresponding state transition events. The one or more immutable contextual log records may enable traceable regulatory oversight of the one or more real-time capital control operations.

FIG. 3 illustrates a flowchart 300 depicting a method 300 for updating the one or more optimization policies in distributed cloud environments, in accordance with an embodiment of the present disclosure.

At step 302, the method 300 may include receiving, at the plurality of distributed processing nodes 106a, 106b, 106c . . . 106n, the plurality of financial transaction data streams from a plurality of distributed data sources 104a, 104b, 104c . . . 104n in real time.

In an example scenario, the plurality of distributed processing nodes 106b, 106c . . . 106n includes a first processing node deployed within a private data center, a second processing node deployed within a public cloud environment, and a third processing node deployed at an edge computing location proximate to a transaction origination point. The plurality of distributed data sources 104a, 104b, 104c . . . 104n includes a payment gateway generating card-based transaction events, a core banking system generating account debit and credit events, and a regulatory reporting interface generating compliance-related transaction annotations.

During operation, at a given time interval t1, the payment gateway transmits a first financial transaction data stream to the second processing node. The first financial transaction data stream may include transaction identifiers, transaction amounts, merchant identifiers, and timestamps at a rate of approximately 5,000 events per second Concurrently, the core banking system transmits a second financial transaction data stream to the first processing node at a rate of approximately 1,200 events per second. The second financial transaction data stream may include account balance updates and settlement indicators.

In parallel, the regulatory reporting interface transmits a third financial transaction data stream to the third processing node at a rate of approximately 300 events per second. The third financial transaction data stream may include jurisdictional flags and reporting codes.

At step 304, the method 300 may include generating the context-aware data framework comprising one or more adaptive data structures configured to dynamically encode semantic relationships among a plurality of financial entities, the plurality of transaction attributes, and a plurality of regulatory parameters based on the received plurality of financial transaction data streams. The generated semantic relationships establish contextual dependencies used for subsequent database state evaluation.

In one implementation, following receipt of the plurality of financial transaction data streams at the plurality of distributed processing nodes 106a, 106b, 106c . . . 106n, a context framework generation module processes the incoming data streams to construct the context-aware data framework comprising one or more adaptive data structures. The one or more adaptive data structures include a dynamically extensible graph data structure stored in a non-transitory memory. The plurality of distributed processing nodes 106a, 106b, 106c . . . 106n of the graph correspond to financial entities including transaction originators, transaction recipients, intermediary processing systems, and regulatory jurisdictions.

For example, upon receiving a first transaction event indicating a funds transfer from a first account associated with a first jurisdiction to a second account associated with a second jurisdiction, the context framework generation module generates a first relationship edge linking a node representing the first account entity to a node representing the second account entity. The relationship edge is annotated with transaction attributes including transaction amount, transaction type, timestamp, and settlement channel.

In parallel, regulatory parameters extracted from the financial transaction data streams may be mapped to regulatory parameter nodes representing reporting thresholds, jurisdictional compliance constraints, and temporal reporting windows. The relationship edges are dynamically weighted based on the relevance of the regulatory parameters to the corresponding transaction attributes. For instance, a cross-jurisdiction transfer results in assignment of a higher regulatory relevance weight to the relationship edge linking the two account entities.

As additional financial transaction data streams are received, the adaptive data structures are incrementally updated by adding new nodes, modifying existing relationship edges, and adjusting edge weights in real time. The aforementioned dynamic encoding enables the context-aware data framework to reflect evolving semantic relationships among the plurality of financial entities, transaction attributes, and regulatory parameters, thereby providing a machine-interpretable contextual representation for subsequent database state transitions and real-time capital control operations.

At step 306, the method 300 may include detecting, within the context-aware data framework, the one or more variations in one or more transaction context, assessed risk exposure, and capital flow conditions by analyzing changes in the generated semantic relationships encoded by the adaptive data structures.

For example, a variation in transaction context, indicated by a deviation in transaction frequency and jurisdictional association encoded in the relationship edges. Further, the variation in assessed risk exposure, indicated by increased weighting of regulatory relevance parameters associated with the modified edges. Further, the variation in capital flow conditions, indicated by a change in aggregate capital flow direction and concentration encoded across multiple related edges. The detected variations are generated as structured context deviation indicators and are forwarded to subsequent database state transition processing for updating the capital and compliance posture within the context-aware data framework.

At step 308, the method 300 may include updating the one or more database states within the context-aware data framework by executing one or more machine-implemented state transition rules based on the detected one or more variations.

In an implementation, the context-aware data framework maintains the one or more database states stored in a distributed memory, including a capital allocation state, a liquidity availability state, and a compliance exposure state. Each database state is represented as a versioned state object associated with a corresponding set of semantic relationships encoded by the adaptive data structures.

Each state transition rule is defined as a conditional mapping between an input variation pattern and a corresponding state update operation. For example, upon detecting the variation indicating an increased concentration of capital flow toward entities associated with a different regulatory jurisdiction, the financial data management engine 110 selects a first state transition rule configured to adjust the compliance exposure state. Execution of the first state transition rule results in incrementing a jurisdiction-specific exposure counter and updating a compliance state version identifier.

In parallel, detection of a sustained increase in transaction frequency associated with a particular account entity triggers execution of a second state transition rule configured to update the liquidity availability state. The second rule recalculates a liquidity utilization metric based on the updated semantic relationships and writes a revised liquidity availability value into the corresponding database state object.

Each executed state transition rule produces the updated database state by modifying one or more state parameters and generating a new state version linked to the semantic relationships that caused the transition. The updated database states are stored within the context-aware data framework and are made available for subsequent real-time capital control operations and distributed state synchronization.

At step 310, the method 300 may include executing the one or more real-time capital control operations within the context-aware data framework based on the updated one or more database states. The one or more real-time capital control operations may be executed by applying one or more adaptive constraint enforcement mechanisms to at least one of transaction routing, liquidity allocation, and compliance threshold management.

For example, an updated liquidity availability state indicates a reduced liquidity margin for a particular transaction channel. Based on this updated database state, the capital control execution module applies an adaptive constraint enforcement mechanism that modifies transaction routing parameters, such that incoming financial transactions associated with the transaction channel are dynamically rerouted to an alternative processing path with available liquidity.

In another example, an updated capital allocation state reflects an increased allocation concentration toward a specific entity group. In response, the capital control execution module applies an adaptive constraint enforcement mechanism to liquidity allocation by adjusting allocation limits associated with subsequent transactions linked to the entity group, thereby preventing further concentration without interrupting transaction processing.

In a further example, an updated compliance exposure state indicates that a regulatory threshold is approaching a predefined limit. Based on the updated database state, the capital control execution module applies an adaptive constraint enforcement mechanism to compliance threshold management by dynamically lowering an allowable transaction parameter for transactions associated with the relevant regulatory context.

In each case, the real-time capital control operations are executed within the context-aware data framework using the updated database states as control inputs, and the applied adaptive constraint enforcement mechanisms operate continuously to influence transaction routing, liquidity allocation, and compliance threshold management in real time.

At step 312, the method 300 may include replicating, execution of the one or more real-time capital control operations, the updated one or more database states across the plurality of distributed processing nodes 106a, 106b, 106c . . . 106n by performing consensus-based propagation. The consensus-based propagation maintains a consistent capital control state across the plurality of distributed processing nodes 106a, 106b, 106c . . . 106n.

For example, a first processing node executes a real-time capital control operation that results in an updated capital allocation state and an updated compliance exposure state. The first processing node packages the updated database states together with corresponding state version identifiers into a replication message.

The replication message is transmitted to the plurality of distributed processing nodes 106a, 106b, 106c . . . 106n participating in a distributed consensus group. Each the plurality of distributed processing nodes 106a, 106b, 106c . . . 106n independently validates the received replication message by verifying the state version identifiers and ensuring that the state transition sequence is consistent with a previously agreed ordering of state updates.

Upon successful validation by a quorum of the plurality of distributed processing nodes 106a, 106b, 106c . . . 106n, a consensus decision is reached to accept the updated database states. The accepted database states are then applied locally at each of the plurality of distributed processing nodes 106a, 106b, 106c . . . 106n, thereby synchronizing the capital allocation state and the compliance exposure state across the plurality of distributed processing nodes.

In the event that a peer processing node is temporarily unavailable during the consensus process, the consensus-based propagation mechanism records the pending state update and propagates the updated database states to the unavailable node upon rejoining the consensus group, thereby ensuring eventual consistency of the replicated database states across the distributed processing nodes.

At step 314, the method 300 may include generating, subsequent to the replication of the updated database states, the one or more immutable contextual log records within the context-aware data framework. The one or more immutable contextual log records may be configured to store the plurality of financial transaction data streams and corresponding state transition events. The one or more immutable contextual log records may enable traceable regulatory oversight of the one or more real-time capital control operations.

In an embodiment, for generating the context-aware data framework, the method 300 may include constructing a multi-layer data representation including an entity relationship layer encoding associations between financial entities, a transaction context layer encoding temporal and behavioral attributes of transactions, the regulatory context layer encoding jurisdiction-specific compliance parameters. The updates in layer trigger recalculation of contextual dependencies in the remaining layers.

In an example scenario, the plurality of distributed processing nodes 106a, 106b, 106c . . . 106n receives real-time financial transaction data streams from multiple geographically distributed payment systems. During normal operation, the context-aware data framework encodes baseline semantic relationships among account entities, transaction channels, and regulatory parameters using adaptive graph-based data structures.

At a given time interval, one processing node detects a sustained increase in transaction frequency associated with a specific transaction channel. This change modifies multiple semantic relationship weights within the adaptive data structures, resulting in detection of a variation in transaction context and capital flow concentration.

Based on the detected variation, one or more machine-implemented state transition rules are executed, resulting in an updated liquidity availability state and a revised capital allocation state. Using the updated database states, the system executes real-time capital control operations by applying adaptive constraint enforcement mechanisms that dynamically adjust transaction routing parameters to redistribute load across alternative processing channels.

Following execution, the updated database states are replicated across peer processing nodes using consensus-based propagation, ensuring consistent capital control behavior across the distributed environment.

In another example scenario, the context-aware data framework receives transaction data streams indicating transactions spanning multiple regulatory jurisdictions. Adaptive data structures encode semantic relationships linking transaction attributes with jurisdiction-specific regulatory parameters.

As transaction events accumulate, the framework detects a change in jurisdictional linkage patterns encoded in the semantic relationships, resulting in a variation in assessed risk exposure and compliance posture. The detected variation triggers execution of a machine-implemented state transition rule that updates a compliance exposure database state.

Based on the updated compliance exposure state, the system executes a real-time capital control operation by applying an adaptive constraint enforcement mechanism to compliance threshold management, dynamically adjusting transaction parameter limits associated with the affected jurisdiction.

The updated compliance exposure state is subsequently propagated across the plurality of distributed processing nodes 106a, 106b, 106c . . . 106n through consensus-based replication, ensuring that compliance constraints are uniformly enforced throughout the system.

In another example scenario, the plurality of distributed processing nodes 106a, 106b, 106c . . . 106n processes high-volume transaction data streams during a peak operational window. The context-aware data framework incrementally updates semantic relationships representing transaction volume, execution timing, and capital utilization.

Analysis of the adaptive data structures identifies a variation in capital flow conditions characterized by accelerated liquidity consumption within a specific transaction path. A machine-implemented state transition rule is executed to update a liquidity availability state associated with the affected path.

Using the updated liquidity availability state, the system executes a real-time capital control operation by applying an adaptive constraint enforcement mechanism that adjusts liquidity allocation limits in real time, without suspending transaction processing.

The updated liquidity state is replicated across distributed nodes using consensus-based propagation, allowing all nodes to enforce consistent liquidity constraints during continued high-throughput operation.

In another example scenario, a distributed processing node temporarily disconnects from the context-aware data framework while other plurality of distributed processing nodes continues executing real-time capital control operations and updating database states. During the disconnection period, updated database states are versioned and committed through consensus-based propagation among the remaining plurality of distributed processing nodes.

Upon reconnection, the previously disconnected node initiates a reconciliation process by requesting the latest committed database state versions. The consensus mechanism validates the pending updates and propagates the updated database states to the rejoining node.

Once synchronized, the rejoining node resumes processing incoming financial transaction data streams using the evolved context-aware data framework, ensuring continuity of capital control operations without reprocessing historical transactions.

In another example scenario, execution of multiple state transition rules and real-time capital control operations, the system generates immutable contextual log records. Each log record encodes transaction identifiers, associated semantic relationship changes, executed state transition rules, and resulting database state versions.

The immutable contextual log records are cryptographically linked and indexed in temporal order, enabling later reconstruction of the sequence of context evolution, state updates, and control operations. These records are generated concurrently with transaction processing and consensus-based state replication, without introducing processing latency.

The methods may be implemented in any suitable hardware, software, firmware, or combination thereof.

Thus, various embodiments of the present invention enable real-time processing of distributed financial transaction data streams by employing a context-aware data framework that dynamically binds transaction data to evolving contextual representations.

The present invention provides adaptive data structures capable of encoding and updating semantic relationships among financial entities, transaction attributes, and regulatory parameters, thereby reducing reliance on static schemas.

The present invention executes machine-implemented state transition rules based on detected contextual variations. The present invention supports deterministic and reproducible database state evolution under changing transaction conditions.

The present invention allows precise tracking of capital, liquidity, and compliance posture changes over time while supporting rollback and historical comparison. The present invention enables low-latency capital control operations by deriving constraint enforcement mechanisms directly from updated database states rather than recalculating constraints for each transaction.

The present invention ensures consistent replication of updated database states across distributed processing nodes, improving system reliability under partial network or node failures. The present invention minimizes transaction processing delays while maintaining coherence of the context-aware data framework across distributed environments. The present invention provides tamper-resistant traceability of state transitions and control operations without interfering with real-time processing. The present invention improves fault tolerance and recovery by enabling delayed synchronization and eventual consistency for nodes that temporarily disconnect from the distributed framework. The present invention improves scalability and extensibility of the system without reconfiguring core processing logic.

The present invention reduces redundant data processing by performing incremental context updates, thereby lowering computational overhead in high-throughput transaction environments. The present invention supports regulatory adaptability by allowing regulatory parameters to be dynamically encoded and updated within the data framework without requiring structural database modifications.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the”include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A method for managing financial data using a context-aware data framework for real-time capital control, the method comprising:
receiving, at a plurality of distributed processing nodes, a plurality of financial transaction data streams from a plurality of distributed data sources in real time;
generating the context-aware data framework based on the received plurality of financial transaction data streams, wherein the context-aware data framework comprises one or more adaptive data structures configured to dynamically encode one or more semantic relationships among a plurality of financial entities, a plurality of transaction attributes, and a plurality of regulatory parameters, wherein the one or more semantic relationships establish contextual dependencies used for subsequent database state evaluation;
detecting one or more variations in one or more transaction context, assessed risk exposure, and capital flow conditions within the context-aware data framework, by analyzing changes in the generated one or more semantic relationships encoded by the one or more adaptive data structures;
updating one or more database states within the context-aware data framework by executing one or more machine-implemented state transition rules based on the detected one or more variations;
executing one or more real-time capital control operations within the context-aware data framework by applying one or more adaptive constraint enforcement mechanisms to at least one of transaction routing, liquidity allocation, and compliance threshold management based on the updated one or more database states;
replicating, execution of the one or more real-time capital control operations, the updated one or more database states across the plurality of distributed processing nodes by performing consensus-based propagation, wherein the consensus-based propagation maintains a consistent capital control state across the plurality of distributed processing nodes; and
generating, subsequent to the replication of the updated database states, one or more immutable contextual log records within the context-aware data framework, wherein the one or more immutable contextual log records configured to store the received plurality of financial transaction data streams and corresponding state transition events, wherein the one or more immutable contextual log records enable traceable regulatory oversight of the one or more real-time capital control operations.

2. The method of claim 1, wherein the received plurality of financial transaction data streams includes input data for constructing and updating the context-aware data framework.

3. The method of claim 1, wherein the one or more adaptive constraint enforcement mechanisms are dynamically derived from the one or more database states.

4. The method of claim 1, wherein the updated one or more database states indicate an evolved capital and compliance posture derived from the detected variations.

5. The method of claim 1, wherein generating the context-aware data framework comprises:
constructing a multi-layer data representation including:
an entity relationship layer encoding associations between the plurality of financial entities, a transaction context layer encoding temporal and behavioral attributes of transactions, and
a regulatory context layer encoding jurisdiction-specific compliance parameters, wherein updates in layer trigger recalculation of contextual dependencies in the remaining layers.

6. The method of claim 1, wherein the one or more adaptive data structures comprise graph-based data structures having one or more weighted edges, wherein the one or more weighted edges are updated in real time based on observed changes in transaction frequency, capital flow direction, or regulatory parameter relevance.

7. The method of claim 1, wherein detecting the one or more variations in the one or more transaction context comprises:
determining incremental comparison between a current context snapshot and a prior context snapshot stored within the context-aware data framework; and
detecting the one or more variations in the one or more transaction context based on the determined incremental comparison.

8. The method of claim 1, wherein updating the one or more database states by executing the one or more machine-implemented state transition rules, wherein execution of the state transition rules is enabled by a rule evaluation pipeline configured to:
evaluate a context deviation condition derived from changes in the one or more semantic relationships, and
evaluate a capital exposure threshold condition derived from the one or more database states.

9. The method of claim 1, wherein the updated one or more database states comprise at least one of: a capital allocation state, a liquidity availability state, and a compliance exposure state, wherein each state is maintained as a versioned data object to enable rollback and historical comparison.

10. A system for managing financial data using a context-aware data framework for real-time capital control, the system comprising:
a memory;
at least one processor is operatively coupled to the memory, wherein the at least one processor is configured to:
receive, at a plurality of distributed processing nodes, a plurality of financial transaction data streams from a plurality of distributed data sources in real time;
generate the context-aware data framework based on the received plurality of financial transaction data streams, wherein the context-aware data framework comprises one or more adaptive data structures configured to dynamically encode one or more semantic relationships among a plurality of financial entities, a plurality of transaction attributes, and a plurality of regulatory parameters, wherein the one or more semantic relationships establish contextual dependencies used for subsequent database state evaluation;
detect one or more variations in one or more transaction context, assessed risk exposure, and capital flow conditions within the context-aware data framework, by analyzing changes in the generated one or more semantic relationships encoded by the one or more adaptive data structures;
update one or more database states within the context-aware data framework by executing one or more machine-implemented state transition rules based on the detected one or more variations;
execute one or more real-time capital control operations within the context-aware data framework by applying one or more adaptive constraint enforcement mechanisms to at least one of transaction routing, liquidity allocation, and compliance threshold management based on the updated one or more database states;
replicate, execution of the one or more real-time capital control operations, the updated one or more database states across the plurality of distributed processing nodes by performing consensus-based propagation, wherein the consensus-based propagation maintains a consistent capital control state across the plurality of distributed processing nodes; and
generate, subsequent to the replication of the updated database states, one or more immutable contextual log records within the context-aware data framework, wherein the one or more immutable contextual log records configured to store the received plurality of financial transaction data streams and corresponding state transition events, wherein the one or more immutable contextual log records enable traceable regulatory oversight of the one or more real-time capital control operations.

11. The system of claim 10, wherein the received plurality of financial transaction data streams includes input data for constructing and updating the context-aware data framework.

12. The system of claim 10, wherein the one or more adaptive constraint enforcement mechanisms are dynamically derived from the one or more database states.

13. The system of claim 10, wherein the updated one or more database states indicate an evolved capital and compliance posture derived from the detected variations.

14. The system of claim 10, wherein to generate the context-aware data framework, the at least one processor is configured to:
construct a multi-layer data representation including:
an entity relationship layer encoding associations between the plurality of financial entities, a transaction context layer encoding temporal and behavioral attributes of transactions, and
a regulatory context layer encoding jurisdiction-specific compliance parameters, wherein updates in layer trigger recalculation of contextual dependencies in the remaining layers.

15. The system of claim 10, wherein the one or more adaptive data structures comprise graph-based data structures having one or more weighted edges.

16. The system of claim 15, wherein the one or more weighted edges are updated in real time based on observed changes in transaction frequency, capital flow direction, or regulatory parameter relevance.

17. The system of claim 10, wherein to detect the one or more variations in the one or more transaction context, the at least one processor is configured to:
determine incremental comparison between a current context snapshot and a prior context snapshot stored within the context-aware data framework; and
detect the one or more variations in the one or more transaction context based on the determined incremental comparison.

18. The system of claim 10, wherein to update the one or more database states by executing the one or more machine-implemented state transition rules, wherein execution of the state transition rules is enabled by a rule evaluation pipeline using the at least one processor is configured to:
evaluate a context deviation condition derived from changes in the one or more semantic relationships, and
evaluate a capital exposure threshold condition derived from the one or more database states.

19. The system of claim 10, wherein the updated one or more database states comprise at least one of: a capital allocation state, a liquidity availability state, and a compliance exposure state, wherein each state is maintained as a versioned data object to enable rollback and historical comparison.

20. A non-transitory computer-readable medium storing instructions that, when executed, cause a processor to:
receive, at a plurality of distributed processing nodes, a plurality of financial transaction data streams from a plurality of distributed data sources in real time;
generate, based on the received plurality of financial transaction data streams, the context-aware data framework comprising one or more adaptive data structures configured to dynamically encode one or more semantic relationships among a plurality of financial entities, a plurality of transaction attributes and a plurality of regulatory parameters, wherein the generated one or more semantic relationships establish contextual dependencies used for subsequent database state evaluation;
detect, within the context-aware data framework, one or more variations in one or more transaction context, assessed risk exposure, and capital flow conditions by analyzing changes in the one or more semantic relationships encoded by the one or more adaptive data structures; and
update, in response to the detected one or more variations, one or more database states within the context-aware data framework by executing one or more machine-implemented state transition rules;
execute, based on the updated one or more database states, one or more real-time capital control operations within the context-aware data framework by applying one or more adaptive constraint enforcement mechanisms to at least one of transaction routing, liquidity allocation, and compliance threshold management;
replicate, execution of the one or more real-time capital control operations, the updated one or more database states across the plurality of distributed processing nodes by performing consensus-based propagation, wherein the consensus-based propagation maintains a consistent capital control state across the distributed nodes; and
generate, subsequent to the replication of the updated database states, one or more immutable contextual log records within the context-aware data framework, wherein the one or more immutable contextual log records configured to configured to store the received plurality of financial transaction data streams and corresponding state transition events, wherein the one or more immutable contextual log records enable traceable regulatory oversight of the one or more real-time capital control operations.
